(19) United States
(12) Patent Application Publication
(10) Pub. No.: US 2004/0072475 A1
(43) Pub. Date: Apr. 15, 2004

(54) Electrode connector

(75) Inventor: Rud Istvan, Fort Lauderdale, FL (US)

Correspondence Address: BANNER & WITCOFF, LTD., TEN SOUTH WACKER DRIVE, SUITE 3000, CHICAGO, IL, 60606, US

(73) Assignee: GMP Wireless Medicine, Inc., Fort Lauderdale, FL

(21) Appl. No.: 10/613,862

(22) Filed: Jul. 3, 2003

Related U.S. Application Data
(60) Provisional application No. 60/394,080, filed on Jul. 3, 2002.

(51) Int. Cl. H01R 4/48

(52) U.S. Cl. 439/860

(57) ABSTRACT

An electrode connector for connecting a conventional tab electrode or sensor to a lead assembly for use with a physiological data collection system. The electrode connector includes a lead connecting portion for attaching the electrode connector to a lead assembly and a tab connection portion for attaching the electrode connector to a tab electrode or sensor. During use of the present invention, the electrical signals corresponding to physiological data of the patient pass from the tab electrode or sensor, through the electrode connector, and to the lead assembly.

### RELATED APPLICATIONS

The application claims the benefit of the filing date pursuant to 35 U.S.C. § 120 of application Ser. No. 60/394,080, for a ELECTRODE CONNECTOR, filed Jul. 3, 2002, the disclosure and content of which is hereby incorporated by reference in its entirety.

### FIELD OF THE INVENTION

The present invention relates to an electrode connector, more particularly to an electrode connector for a connecting a conventional tab electrode or sensor to a system for collecting physiological data from a patient.

### BACKGROUND OF THE INVENTION

Conventional systems for collecting physiological data from a patient utilize conventional electrodes or sensors selectively placed on the patient's body. Traditionally, multiple cables or leads electrically connect to the electrodes or sensors and the physiological data is transferred from the electrodes or sensors to a patient monitor via the multiple cables or leads. With regard to wireless collection systems or telemetry units, the electrodes or sensors electrically connect to a chest assembly and the physiological data is transferred from the electrodes or sensors to the chest assembly before being wirelessly transmitting to a patient monitor.

One type of electrode or sensor that is commonly used with both the traditional wired systems and the wireless systems is an electrode or sensor having a conductive tab integrally formed thereon. Those electrodes or sensors are commonly referred to as tab electrodes. Such tab electrodes are commonly used for resting 12 lead or discrete ECG. Tab electrodes attach to the cables, wires or chest assemblies via alligator clips. However, many of the wires, cables, and chest assemblies used with conventional physiological data collection systems do not contain alligator clips to connect to the tab electrodes, but rather terminate in snaps designed to be used for so called snap electrodes. Thus, such lead wire sets are not compatible with for use with tab electrodes. Similarly, lead wire sets containing alligator clips are incapable of making a secure connection to conventional snap electrodes. This necessitates having different lead wire sets for the different types of electrodes.

Accordingly, there exists a need for an electrode connector that is capable of connecting a conventional tab electrode to the wires, cables, or chest assemblies used with conventional physiological data systems in situations where such wires, cables, or chest assemblies are equipped with snaps rather than alligator clips. The present invention fills this need. The novel advantages, details, embodiments, features, and objects of the present invention will be apparent to those skilled in the art from the following detailed description of the invention and the accompanying drawings, listed herein below, which are useful in explaining the invention.

### BRIEF SUMMARY OF THE INVENTION

The present invention relates to an electrode connector for connecting a conventional tab electrode or sensor to a lead assembly for use with a physiological data collection system. The electrode connector is constructed of a suitable electrically conductive material and includes a lead connecting portion and tab connection portion. The lead connecting portion attaches the electrode connector to a lead assembly and the tab connection portion attaches the electrode connector to a tab electrode or sensor. During use of the present invention, the electrical signals corresponding to physiological data of the patient pass from the tab electrode or sensor, through the electrode connector, and to the lead assembly.

The lead connecting portion may be shaped and configured such that the lead connecting portion contacts a perimeter of a conductive area on a lead assembly. The connection between the lead connecting portion and the perimeter of the conductive rivet removably secures the electrode connector to the lead assembly and provides an electrical link between the electrode connector and the lead assembly. Alternatively, the electrode connector may include a male portion that can be removably inserted into a corresponding female portion in the conductive area (such as a riveted snap on a chest assembly as disclosed in U.S. patent application entitled “Wireless ECG System” Ser. No. 09/998,733 filed on Nov. 30, 2001, the content of which is incorporated herein by reference in its entirety). The male portion removably secures the electrode connector to the lead assembly and provides an electrical link between the electrode connector and the lead assembly.

The tab connection portion of the electrode connector is defined by retaining arms configured to retain the tab of the tab electrode or sensor there between. Alternatively, the tab connection portion of the electrode connector may be in the form of an alligator clip or clasp. In either embodiment, the tab connection portion functions to mechanically secure the tab electrode or sensor to the electrode connector and provide an electrical link between the tab electrode or sensor and the electrode connector.

### BRIEF DESCRIPTION OF THE DRAWING

The foregoing aspects and many of the advantages of the present invention will become readily appreciated by reference to the following detailed description of the preferred embodiment, when taken in conjunction with the accompanying drawings, wherein:

FIG. 1 depicts an exemplary embodiment of the electrode connector of the present invention in conjunction with a lead assembly;

FIG. 2 depicts an exemplary embodiment of the electrode connector in conjunction with a patient and a lead assembly;

FIG. 3 is a top view of an exemplary embodiment of the electrode connector shown in FIG. 1;

FIG. 4 depicts and exemplary embodiment of the electrode connector in conjunction with a lead assembly and tab electrode or sensor;

FIG. 5A depicts an exemplary embodiment of the electrode connector in conjunction with a lead assembly;

FIG. 5B depicts a top view of the exemplary embodiment of the electrode connector shown in FIG. 5A;

FIG. 6A depicts another exemplary embodiment of the electrode connector;

FIG. 6B depicts a top view of the exemplary embodiment of the electrode connector shown in FIG. 6A;

FIG. 7 depicts another exemplary embodiment of the electrode connector in conjunction with a tab electrode or sensor;

FIG. 8 depicts another exemplary embodiment of the electrode connector in conjunction with a tab electrode or sensor;

FIG. 9 depicts another exemplary embodiment of the electrode connector; and

FIG. 10 depicts another exemplary embodiment of the electrode connector.

### DETAILED DESCRIPTION OF THE INVENTION

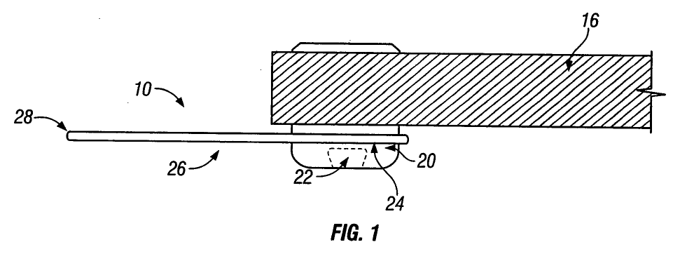

For a better understanding of the present invention, reference may be had to the following detailed description taken in conjunction with the accompanying drawings. FIG. 1 depicts an exemplary embodiment of the electrode connector 10 of the present invention, which operates to electrically connect a conventional tab electrode or sensor 12 to a lead assembly 16. The electrode connector 10 may be used to connect conventional tab electrodes or sensors 12 to both traditional wired systems and wireless systems for collecting physiological data from a patient.

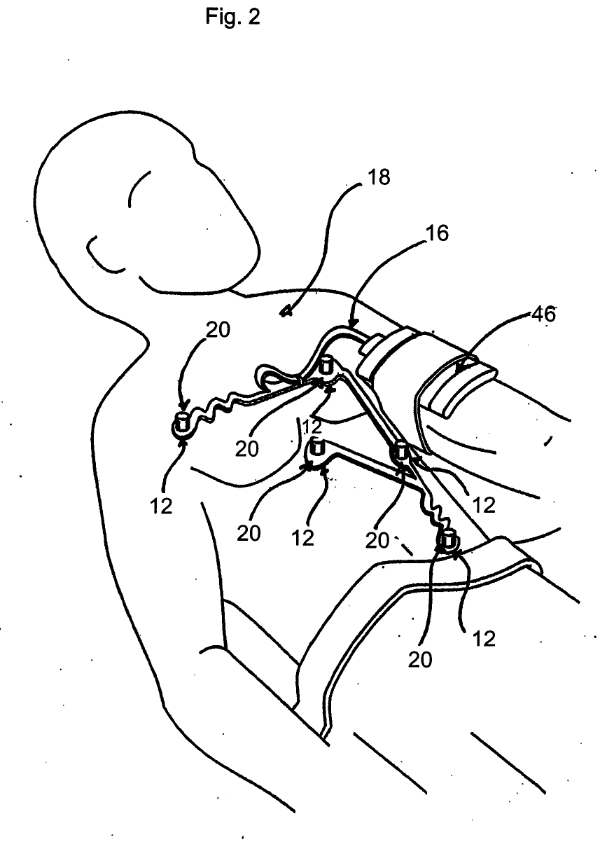

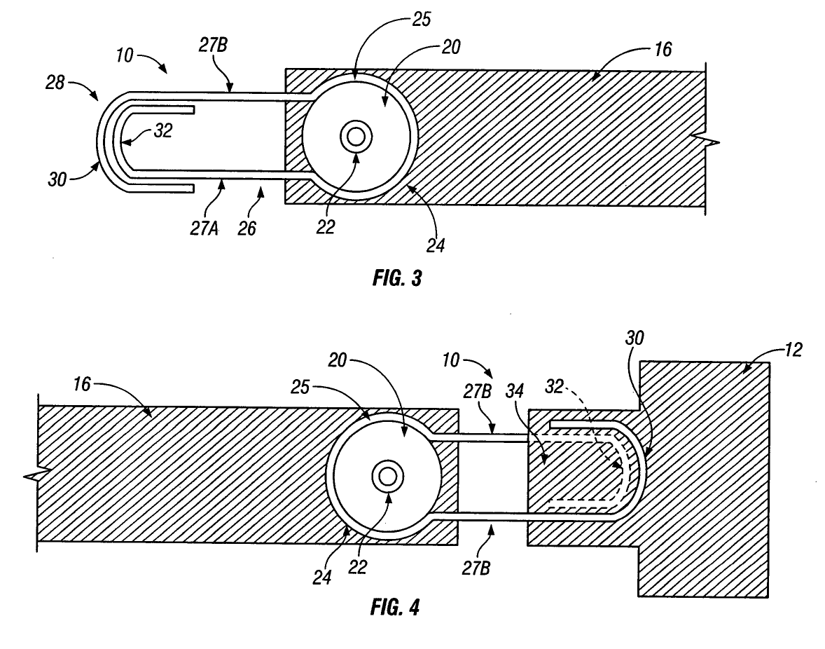

As shown in FIG. 2, the lead assembly 16 connects directly to a patient 18 for collecting physiological data detected by tab electrodes or sensors 12, such as EKG signals, blood pressure data, temperature readings, pulse, respiration rate data, and pulse oximeter data. The tab electrodes or sensors 12 connect to the lead assembly 16 at electrode connection points 20. FIGS. 1, 3, and 4 depict a lead assembly 16 for connecting to a male snap electrode (not shown). Such a lead assembly 16 contains a conductive rivet 20 having a female receptacle 22 for receiving and securing a male portion of the male snap electrode. An exemplary embodiment of the electrode connector 10 of the present invention, as shown in FIGS. 1, 3, and 4, functions to connect a conventional tab electrode or sensor 12 to the lead assembly 16. The electrode connector 10 is constructed of a resilient, electrically conductive material such as beryllium copper or other suitable material. The electrode connector 10 may be fabricated from an integral piece of material or may be constructed of multiple pieces of material bonded or otherwise secured together.

The electrode connector 10 includes a lead connecting portion 24 for removably securing the electrode connector 10 to the conductive rivet 20. The lead connecting portion 24 is generally circular in configuration and removably secures to the conductive rivet 20 by contacting a portion of a perimeter 25 of the conductive rivet 20. The lead connecting portion 24 may have alternative shapes and configurations. For example, the lead connecting portion 24 may be oval, square, triangular, semi-circular, or the like, so long as the connecting portion 24 is appropriately shaped and configured to provide a sufficient connection to mechanically hold the electrode connector 10 to the conductive rivet 20 and to provide an electrical link between the electrode connector 10 and the conductive rivet 20.

The electrode connector 10 further includes an extension portion 26 defined by extension arms 27A and 27B extending from the lead connecting portion 24. The extension portion 26 connects the lead connecting portion 24 to a tab connection portion 28. The tab connection portion 28 is defined by retaining arms 30, 32. The retaining arms 30, 32 are formed by semi-circular loops. The loops that form the retaining arms 30, 32 may be of different shapes if so desired. For example, the loops may be rectangular, square, oval, triangular, helical, or the like. The tab connection portion 28 removably connects to the tab electrode or sensor 12 when a tab 34 on the tab electrode or sensor 12 is inserted between the retaining arms 30, 32. The electrode connector 10 mechanically holds the tab electrode or sensor 12 to the lead assembly 16 and provides an electrical link between the tab electrode or sensor 12 and the lead assembly 16. Accordingly, the electrical signals corresponding to physiological data of the patient pass from the tab electrode or sensor 12 to the electrode connector 10 and to the lead assembly 16.

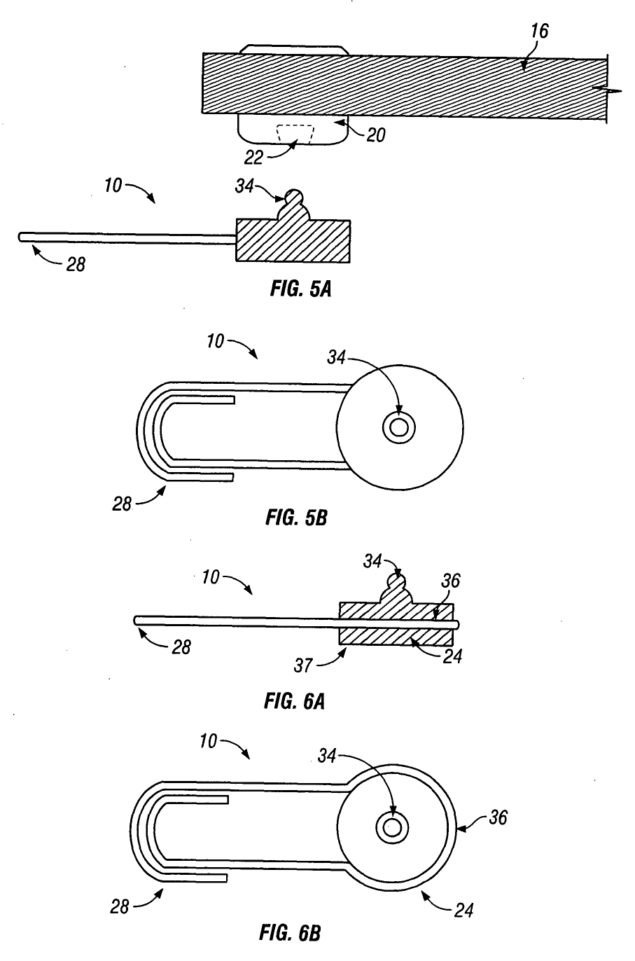

In another embodiment of the present invention, the electrode connector 10 may include a male portion 34. As shown in FIGS. 5A and 5B, the male portion 34 may be integrally formed on the electrode connector 10 or may be a separate piece of material that is bonded or otherwise fixedly secured to the electrode connector 10. Alternatively, as shown in FIGS. 6A and 6B, the lead connecting portion 24 may removably secure the electrode connector 10 to the male portion 34 by contacting a portion of a perimeter 36 of a base 37 of the male portion 34. The contact between the lead connecting portion 24 and the perimeter 36 establishes a mechanical hold between the lead connecting portion 24 and the perimeter 36. In both embodiments shown in FIGS. 5A, 5B, 6A, and 6B, the male portion 34 removably inserts into the female receptacle 22 of the conductive rivet 20 to mechanically hold the electrode connector 10 in place and provide an electrical link between the electrode connector 10 and the lead assembly 16. The electrode connector 10 having a male portion 34 is useful in connecting a tab electrode or sensor 12 to a lead assembly 16 having an electrode or sensor connector assembly as described in U.S. patent application entitled “FASTENER ASSEMBLY” (Attorney Docket No. 005123.00053, Express Mail No. EV 075511056 US) filed on Jul. 1, 2001, the content of which is incorporated herein by reference in its entirety.

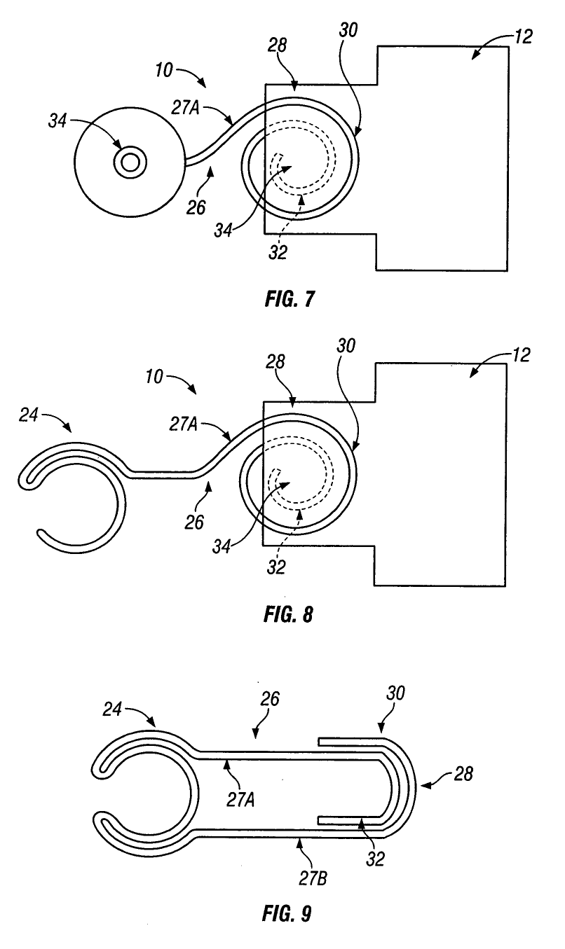

In other embodiments of the present invention, as shown in FIGS. 7-9, the electrode connector 10 is constructed from an integral piece of resilient, electrically conductive material. Referring to FIG. 7, the retaining arms 30, 32 of the tab connection portion 28 are formed from a helical loop. The extension portion 26 is defined by the single extension arm 27A, which connects the tab connection portion 28 to the male portion 34. The tab electrode or sensor 12 is removably secured to the electrode connector 10 when the tab 34 is inserted between the retaining arms 30, 32. The male portion 34 inserts into the corresponding female receptacle 22 (not shown) of the conductive rivet 20 (not shown) to removably secure the electrode connector 10 to the lead assembly 16 (not shown).

Similarly, as shown in FIG. 8, the retaining arms 30, 32 of the tab connection portion 28 are formed from a helical loop. The extension portion 26 is defined by the single extension arm 27A, which connects the tab connection portion 28 to the lead connecting portion 24. The lead connecting portion 24 is semicircular in shape. The lead connecting portion 24 contacts a portion of the perimeter 25 (not shown) of the conductive rivet 20 (not shown) to secure the electrode connector 10 to the lead assembly 16 (not shown). Alternatively, the lead connecting portion 24 could connect the male portion 34 (not shown) by contacting a portion of the perimeter 36 of the base 37 of the male portion 34.

Referring now to FIG. 9, the tab connection portion 28 is defined by retaining arms 30, 32. The retaining arms 30, 32 are formed by semi-circular loops. The extension portion 26, which is defined by extension arms 27A and 27B connect the tab connection portion 28 to the lead connecting portion 24. Similar to the exemplary embodiment as shown in FIG. 8, the lead connecting portion 24 is semicircular in shape.

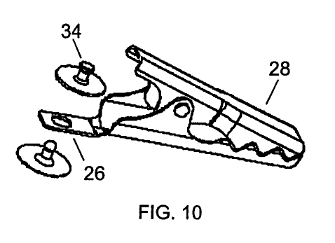

Referring to FIG. 10, in yet another embodiment of the present invention, the tab connection portion 28 may be in the form of an alligator clip or clasp. The alligator clip or clasp may be integrally formed on the electrode connector 10 or may be a separate piece of material that is bonded or otherwise fixedly secured to the extension portion 26 of the electrode connector 10. The alligator clip or clasp removably connects to the tab 34 of the tab electrode or sensor 12. In addition, the lead connecting portion may be defined a male portion that is configured to insert into the female receptacle of the conductive rivet. The advantage over present lead wires terminating in alligator clips is that when the devices of the present invention are removed, the lead wire set can be used with conventional snap electrodes without changing the lead wire set.

In the foregoing specification, the present invention has been described with reference to specific exemplary embodiments thereof. It will be apparent to those skilled in the art, that a person understanding this invention may conceive of changes or other embodiments or variations, which utilize the principles of this invention without departing from the broader spirit and scope of the invention. The specification and drawings are, therefore, to be regarded in an illustrative rather than restrictive sense.

We claim:

1. A connector to connect a sensor to a lead assembly comprising, in combination:
a lead connecting portion for securing the connector to a conductive rivet of the lead assembly;
an extension portion defined by at least one extension arm extending from the lead connecting portion; and
a tab connection portion extending from the extension portion.

2. The connector of claim 1 wherein the connector is constructed of electrically conductive material.

3. The connector of claim 1 wherein the lead connecting portion is configured to connect to a male portion by contacting a portion of a perimeter of a base of the male portion, the male portion configured to insert into a female receptacle of the conductive rivet.

4. The connector of claim 1 wherein the lead connecting portion is defined by semicircular loop.

5. The connector of claim 1 wherein the lead connecting portion is defined by loop.

6. The connector of claim 1 wherein in the lead connecting portion is defined by a male portion integrally formed on the connector, the male portion configured to insert into a female receptacle of the conductive rivet.

7. The connector of claim 1 wherein the tab connection portion is defined by at least one retaining arm, the at least one retaining arm defined by a semi-circular loop.

8. The connector of claim 1 wherein the tab connection portion is defined by at least one retaining arm, the at least one retaining arms defined by a helical loop.

9. The connector of claim 1 wherein the tab connection portion is configured to connect to a tab on the sensor.

10. The connector of claim 1 wherein the tab connection portion is defined by an alligator clip.

11. The connector of claim 10 wherein the alligator clip is integrally formed on the connector.

12. The connector of claim 10 wherein the lead connecting portion is defined by a male portion, the male portion configured to insert into a female receptacle of the conductive rivet.

13. The connector of claim 1 wherein the sensor is configured to detect physiological parameters selected from the group consisting of EKG signals, blood pressure data, temperature readings, pulse, respiration rate data, and pulse oximeter data.
